(19) United States
(12) Patent Application Publication
(10) Pub. No.: US 2015/0212543 A1
(43) Pub. Date: Jul. 30, 2015

(54) ELECTRONIC DEVICE

(71) Applicant: HTC Corporation, Taoyuan County (TW)

(72) Inventors: Shih-Po Chien, Taoyuan County (TW); Pi-Lin Lo, Taoyuan County (TW); Yen-Cheng Lin, Taoyuan County (TW); Chia-Huan Chang, Taoyuan County (TW)

(73) Assignee: HTC Corporation, Taoyuan County (TW)

(21) Appl. No.: 14/166,859

(22) Filed: Jan. 29, 2014

(51) Int. Cl. G06F 1/16; G06F 3/041; G06F 3/044

(52) U.S. Cl. CPC G06F 1/169; G06F 3/044; G06F 3/0412; G06F 3/0416

(57) ABSTRACT

An electronic device including a casing, a conductor and a touch module is provided. The casing has an appearance surface and an opening extending to the appearance surface. The conductor is disposed in the opening and is exposed by the appearance surface, and is electrically isolated to the casing. The touch module is disposed within the casing and is electrically connected to the conductor to construct a touch key.

### TECHNICAL FIELD

The invention relates to an electronic device, and particularly relates to an electronic device having touch keys.

### RELATED ART

Commonly used electronic devices (for example, mobile phones, smart phones, tablet PCs and notebooks, etc.) are all configured with keys to facilitate a user inputting instructions. The types of commonly used keys include physical keys and touch keys. The physical key is generally separated from a casing of the electronic device, and can be moved relative to the casing of the electronic device to provide a mechanical stroke so as to trigger a switch component to generate an electronic signal. Moreover, the touch key includes a sensing circuit hidden under the casing of the electronic device and a key pattern set on the casing of the electronic device, and thus a controller determines whether an object (for example, user's finger) touches or approaches to the key pattern through the sensing circuit, so as to generate a corresponding electronic signal.

It should be noticed that the touch keys generally adopt a projected capacitive touch technique, so that the part of the casing located between the sensing circuit and the key pattern cannot adopt a metal material, so as to avoid influencing a sensing function. However, as the casing of the electronic device cannot adopt the metal material, an appearance design of the casing of the electronic device is limited.

### SUMMARY OF THE INVENTION

The invention is directed to an electronic device having touch keys.

The invention provides an electronic device including a casing, a conductor and a touch module. The casing has an appearance surface and an opening extending to the appearance surface. The conductor is disposed in the opening and is exposed by the appearance surface, and is electrically isolated to the casing. The touch module is disposed within the casing and is electrically connected to the conductor to construct a touch key.

According to the above descriptions, in the invention, the conductor penetrates through the casing to serve as an electrode for capacitive touch sensing.

To make the above features and advantages of the invention more comprehensible, several embodiments accompanied with drawings are described in detail as follows.

### BRIEF DESCRIPTION OF THE DRAWINGS

FIG. 1 is a front view of an electronic device according to an embodiment of the invention.

FIG. 2 is an exploded view of a part of components of the electronic device of FIG. 1.

FIG. 3 is a cross-sectional view of the electronic device of FIG. 1 along line I-I.

FIG. 4 is a cross-sectional view of an electronic device according to another embodiment of the invention.

FIG. 5 illustrates a principle of a self capacitance touch sensing technique.

FIG. 6 illustrates a principle of a mutual capacitance touch sensing technique.

### DESCRIPTION OF THE EMBODIMENTS

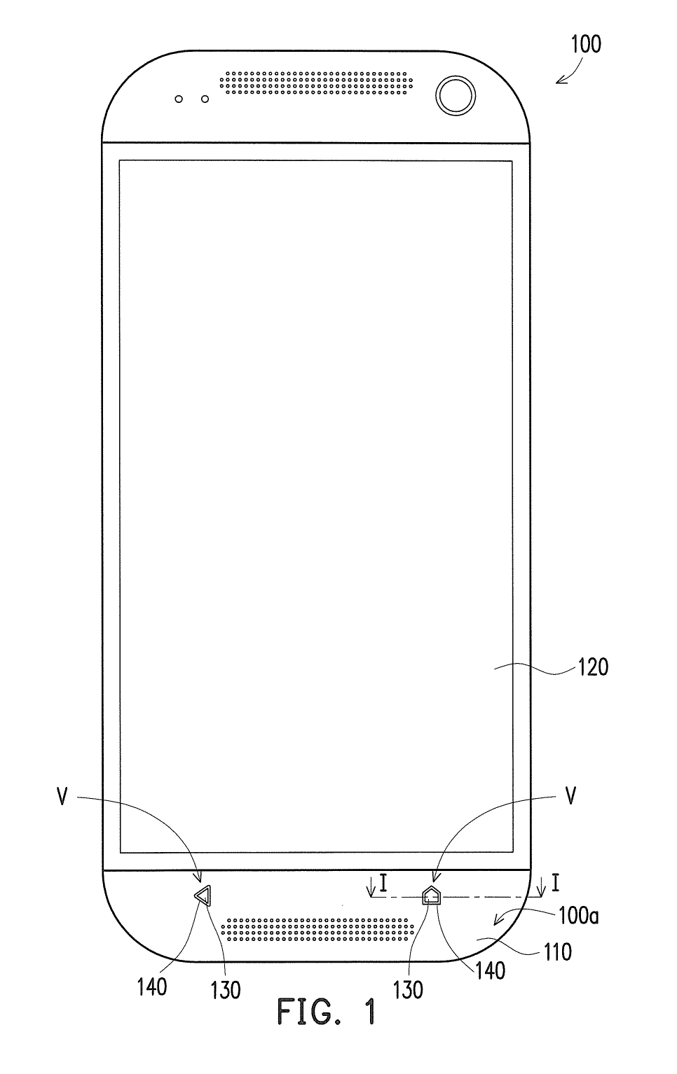

Referring to FIG. 1, the electronic device 100 of the present embodiment is a smart phone, but is not limited thereto, and other electronic devices requiring touch keys (for example, a tablet PC and a notebook, etc.) may also be applied. The electronic device 100 includes a casing 110 and a display screen 120 disposed on the casing 110. Moreover, the electronic device 100 further has a plurality of touch keys V located under the display screen 120.

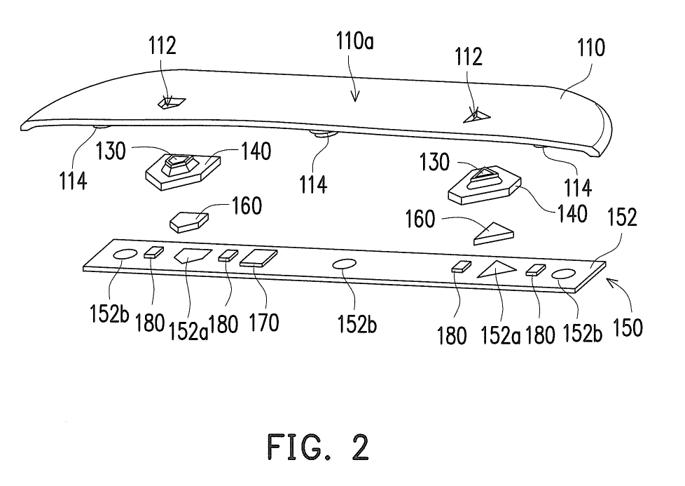

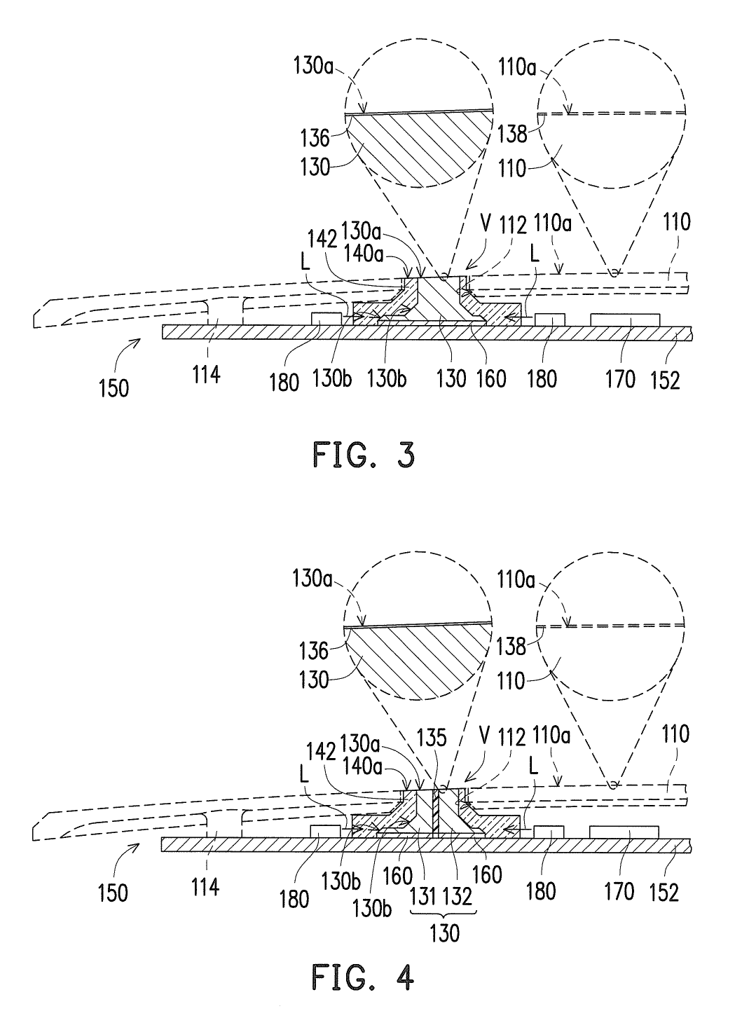

Referring to FIG. 2 and FIG. 3, the casing 110 has an appearance surface 110a and a plurality of openings 112. The openings 112 penetrate through the casing 110 and extend to the appearance surface 110a. The electronic device 100 further includes a plurality of conductors 130. The conductors 130 are respectively disposed in the openings 112 and exposed by the appearance surface 110a to construct the touch keys V. In the present embodiment, a material of the casing 110 includes metal, especially the part of the casing 110 shown in FIG. 2 and FIG. 3, so as to present required appearance texture. Similarly, a material of the conductor 130 also includes metal, which may be the same material with that of the casing 110, so as to present an integral appearance texture. However, the invention is not limited thereto, and the material of the casing 110 may also be other non-metal materials.

Referring to FIG. 1, a contour of the opening 112 at the appearance surface 110a may be conformal to a contour of the corresponding conductor 130 at the appearance surface 110a. Therefore, the conductor 130 and the corresponding opening 112 may form a required pattern, for example, a polygon, etc., to indicate a function corresponding to the touch key V, for example, next page or homepage, etc. Referring to FIG. 3, a contour of a surface 130a of the conductor 130 exposed by the appearance surface 110a may be complied with a contour of the appearance surface 110a of the casing 110, such that the appearance surface 110a of the casing 110 and the surfaces 130a of the conductors 130 may present one even surface, or have a step difference, such that when a finger touches the surfaces, the user may feel a position of the touch key V, though the invention is not limited thereto. The surface 130a of the conductor 130 may be slightly lower than or higher than the appearance surface 110a to cope with a design requirement on appearance.

Referring to FIG. 1 to FIG. 3, the electronic device 100 may further include a plurality of isolation parts 140. Each of the isolation parts 140 is disposed between the corresponding opening 112 and the conductor 130 to isolate the conductor 130 from the casing 110. As the casing 110 is conductive (for example, the material of the casing 110 includes metal), the isolation part 130 are insulative for electrically isolating the conductors 130 from the casing 110. In the present embodiment, each of the isolation parts 140 extends to the opening 112 and is exposed by the appearance surface 110a, and a contour of a surface 140a of the isolation part 140 exposed by the appearance surface 110a is complied with the contour of the appearance surface 110a of the casing 110, such that the appearance surface 110a of the casing 110, the surfaces 130a of the conductors 130 and the surfaces 140a of the isolation parts 140 present an outer contour with consistence, though the invention is not limited thereto. The surfaces 140a of the isolation parts 140 may also be slightly lower than or higher than the appearance surface 110a, such that when a finger touches the surface, the user may feel a position of the touch key V, so as to cope with a design requirement on appearance.

Referring to FIG. 1 to FIG. 3, the electronic device 100 may further include a touch module 150. The touch module 150 is disposed within the casing 110 and is electrically connected to the conductors 130. In the present embodiment, the touch module 150 includes a circuit board 152. The circuit board 152 is disposed within the casing 110 and is electrically connected to the conductors 130. The electronic device 100 may further include a plurality of conductive pads 160 having both properties of conductivity and elasticity simultaneously. Each of the conductive pads 160 are disposed between the corresponding conductor 130 and the circuit board 152 for electrically connecting the conductor 130 and the circuit board 152. In detail, the circuit board 152 has a plurality of first pads 152a and a plurality of second pads 152b. The conductors 130 are electrically connected to the first pads 152a through the conductive pads 160, and the casing 110 has electrical conductivity and is electrically connected to the second pads 152b. The casing 110 has a plurality of protrusions 114, and each of the protrusions 114 leans against the corresponding second pad 152b.

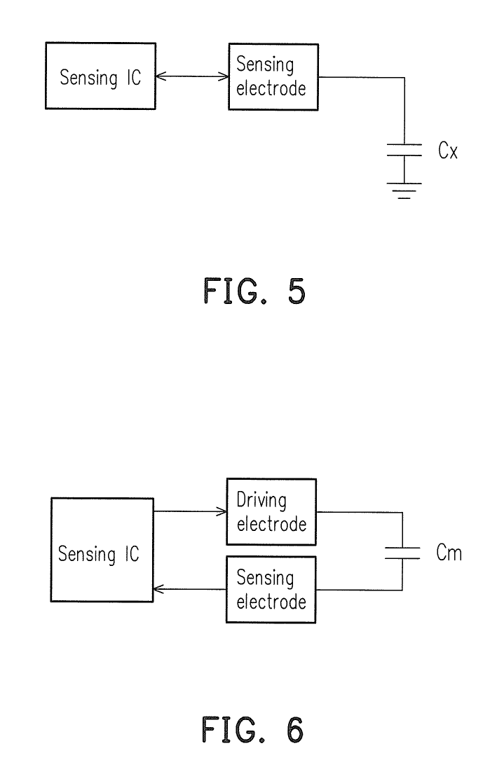

When a self capacitance touch sensing technique is adopted (shown in FIG. 5), the conductor 130 may be used alone as a single sensing electrode for signal input, and the casing 110 located beside the conductor 130 is required to be connected to ground. A sensing IC (for example, a controller 170 of FIG. 3) may charge the conductor 130 (i.e. the sensing electrode), and then the sensing IC senses an electronic signal when the conductor 130 discharges. When the conductor 130 is touch by a hand, the electronic signal is changed due to a charge of the finger, and it is detected that the conductor 130 is touched.

Moreover, when a mutual capacitance touch sensing technique is adopted (shown in FIG. 6), the casing 110 and the conductor 130 may respectively serve as a driving electrode and a sensing electrode, where the driving electrode serves as a signal transmitting terminal, and the sensing electrode serves as a signal receiving terminal. When the finger approaches, a signal received by the signal receiving terminal is changed due to contact of the finger, and it is determined that a finger contact is occurred. In the mutual capacitance touch sensing technique, a surface of the electrode generally has an insulation layer, for example, a surface of each of the current touch keys has a layer of glass for isolation.

In the present embodiment, as shown in FIG. 3, the surface 130a of the conductor 130 exposed by the appearance surface 110a has an insulation layer 136, which is, for example, generated when anodizing process is performed to the surface 130a, so as to prevent the conductor 130 from oxidation, and the insulation layer 136 does not influence the finger to deliver the electronic signal to the conductor 130. Moreover, the appearance surface 110a may also have an insulation layer 138. Generally, a surface of an electrode of capacitive type (including self capacitance type and mutual capacitance type) is required to has an insulation layer, though an electrode of self capacitance may still sense a variation of charge regardless of whether the surface thereof has an insulation layer or not, such that the surface of the self capacitance electrode does not necessarily has an insulation layer (i.e. the insulation layer 136 and the insulation layer 138).

In another embodiment, as shown in FIG. 4, when the mutual capacitance touch sensing technique is adopted (shown in FIG. 6), the conductor 130 may be divided into two portions (i.e. a first conductive portion 131 and a second conductive portion 132) to serve as a driving electrode and a sensing electrode, and respectively serve as the signal transmitting terminal and the signal receiving terminal. The first conductive portion 131 and the second conductive portion 132 of the conductor 130 have an insulator 135 there between for insulation. The first conductive portion 131 is electrically connected to the circuit board 152 through one conductive pad 160, and the second conductive portion 132 is electrically connected to the circuit board 152 through another conductive pad 160.

Moreover, the electronic device 100 further includes a controller 170, which is disposed on the circuit board 152 and is electrically connected to the first pads 152a and the second pads 152b through an internal circuit of the circuit board 152.

Referring to FIG. 1 to FIG. 3, in the present embodiment, the electronic device 100 further includes a plurality of light emitting elements 180, which are disposed within the casing 110 and located on the circuit board 152 for emitting light L, as shown in FIG. 3. Therefore, when the isolation part 140 has light permeability, the isolation part 140 may guide the light L emitted by the light emitting elements 180 to surrounding of the conductor 130 at the appearance surface 110a. In detail, the isolation part 140 has a light emitting portion 142 around the periphery of the conductor 130, and the light L emits out through the light emitting portion 142.

Therefore, when the contour of the opening 112 at the appearance surface 110a may be conformal to the contour of the conductor 130 at the appearance surface 110a, and the conductor 130 and the corresponding opening 112 may form a required pattern, the isolation part 140 extended between the opening 112 and the conductor 10 may also form the required pattern, for example, a polygon, etc., to indicate the function corresponding to the touch key V, for example, return or homepage, etc. Moreover, the conductor 130 has a plurality of reflective surfaces 130b, shown in FIG. 3, for reflecting the light emitted by the light emitting element 180 to the surrounding of the conductor 130 at the appearance surface 110a.

In summary, in the present invention, the conductors penetrate through the casing to serve as touch keys. The isolation parts are disposed between the casing and the conductors to isolate the conductors from the casing, which is adapted to a situation that the appearance surface is constructed by a conductive or metal portion of the casing, and the isolation parts are disposed between the casing and the conductors to achieve electrical isolation. The conductor itself may serve as a single sensing electrode for self capacitance touch sensing, or the casing and the conductor may serve as a pair of sensing electrodes for mutual capacitance touch sensing. The material of the isolation part may be a light permeable material, which is suitable for guiding the light emitted by the light emitting element to the surrounding of the conductor at the opening to provide illumination.

Although the invention has been described with reference to the above embodiments, it is apparent to one of the ordinary skill in the art that modifications to the described embodiments may be made without departing from the spirit of the disclosure. Accordingly, the scope of the invention will be defined by the attached claims not by the above detailed descriptions.

What is claimed is:

1. An electronic device, comprising:
a casing, having an appearance surface and an opening extending to the appearance surface;
a conductor, disposed in the opening and exposed by the appearance surface, and electrically isolated to the casing; and
a touch module, disposed within the casing, and electrically connected to the conductor to construct a touch key.

2. The electronic device as claimed in claim 1, wherein a material of the casing comprises metal, and a material of the conductor comprises metal.

3. The electronic device as claimed in claim 1, wherein the appearance surface and a surface of the conductor exposed by the appearance surface are able to have a step so that a position of the touch key is able to be felt through a finger.

4. The electronic device as claimed in claim 1, wherein a contour of the opening at the appearance surface is conformal to a contour of the conductor at the appearance surface.

5. The electronic device as claimed in claim 1, further comprising:
an isolation part, disposed between the opening and the conductor to isolate the conductor from the casing.

6. The electronic device as claimed in claim 5, wherein the casing is conductive, and the isolation part is insulative for electrically isolating the conductor from the casing.

7. The electronic device as claimed in claim 5, wherein the isolation part extends to the opening and is exposed by the appearance surface, and the appearance surface and a surface of the isolation part exposed by the appearance surface are able to have a step difference so that a position of the touch key is able to be felt through a finger.

8. The electronic device as claimed in claim 5, further comprising:
a light emitting element, disposed within the casing to emit light, wherein the isolation part has light transparency to guide the light emitted by the light emitting element to surrounding of the conductor at the appearance surface.

9. The electronic device as claimed in claim 8, wherein the conductor has at least one reflective surface for guiding the light emitted by the light emitting element to surrounding of the conductor at the appearance surface.

10. The electronic device as claimed in claim 1, wherein the touch module further comprises:
a circuit board, disposed within the casing and electrically connected to the conductor.

11. The electronic device as claimed in claim 10, further comprising:
a conductive pad, disposed between the conductor and the circuit board to electrically connect the conductor and the circuit board.

12. The electronic device as claimed in claim 10, wherein the circuit board has a first pad and a second pad, the conductor is electrically connected to the first pad, and the casing has conductivity and is electrically connected to the second pad.

13. The electronic device as claimed in claim 12, wherein the casing has a protrusion, and the protrusion leans against the second pad.

14. The electronic device as claimed in claim 10, further comprising:
a controller, disposed on the circuit board and electrically connected to the first pad and the second pad.

15. The electronic device as claimed in claim 10, further comprising:
a light emitting element, disposed within the casing and disposed on the circuit board to emit light, wherein the isolation part has light transparency to guide the light emitted by the light emitting element to surrounding of the conductor at the appearance surface.

16. The electronic device as claimed in claim 1, wherein the conductor has a reflective surface to guide the light emitted by the light emitting element to surrounding of the conductor at the appearance surface.

17. The electronic device as claimed in claim 1, further comprising:
a display screen, disposed on the casing, wherein the conductor is located beside the display screen.

18. The electronic device as claimed in claim 1, wherein a surface of the conductor exposed by the appearance surface has an insulation layer.

19. The electronic device as claimed in claim 1, wherein the appearance surface has an insulation layer.

20. The electronic device as claimed in claim 1, further comprising:
an insulator, separating the conductor into a first conductive portion and a second conductive portion, wherein the first conductive portion is a signal transmitting terminal, and the second conductive portion is a signal receiving terminal.
